(19) United States
(12) Patent Application Publication
(10) Pub. No.: US 2024/0393713 A1
(43) Pub. Date: Nov. 28, 2024

(54) CARTRIDGE

(71) Applicant: CANON KABUSHIKI KAISHA, Tokyo (JP)

(72) Inventors: MITSUHIRO SATO, Tokyo (JP); HIROYUKI MUNETSUGU, Kanagawa (JP); SHINICHI NISHIDA, Kanagawa (JP); GOSHI OZAKI, Kanagawa (JP); MASAHIRO SUETSUGU, Kanagawa (JP); SOHTA SUGIMOTO, Kanagawa (JP)

(21) Appl. No.: 18/670,444

(22) Filed: May 21, 2024

(30) Foreign Application Priority Data
May 23, 2023 (JP) 2023-084304

(51) Int. Cl. G03G 15/08

(52) U.S. Cl. CPC G03G 15/0867; G03G 15/0808; G03G 2215/066

(57) ABSTRACT

A cartridge to which a toner container is detachably attachable includes a development roller, a storage unit to store toner to be carried by the development roller, an attachment portion, and first, second, and third contact portions on a bottom surface of the cartridge to be brought into contact with a horizontal plane. The cartridge can be oriented in a positioning direction in which the attachment portion is positioned above the storage unit and the cartridge contacts the horizontal plane. When the cartridge in the positioning direction is viewed in a gravity direction, a part of the attachment portion overlaps with a first region. The first region is surrounded by a first virtual line connecting the first and second contact portions, a second virtual line connecting the second and third contact portions, a third virtual line connecting the third and first contact portions, the first, second, and third contact portions.

### BACKGROUND

### Field

The present disclosure relates to a cartridge.

### Description of the Related Art

In some known electrophotographic image forming apparatuses, a toner container is attached to a cartridge that is attachable to and detachable from the main body of the electrophotographic image forming apparatus, and toner is supplied from the toner container to the cartridge (Japanese Patent Laid-Open No. 2021-26218).

### SUMMARY

According to an aspect of the present disclosure, a cartridge which a toner container is attachable to and detachable from, the cartridge including a development roller and a storage unit for storing toner to be carried by the development roller, the cartridge includes an attachment portion having a supply inlet through which toner is supplied to the storage unit from outside of the cartridge, wherein the toner container is attachable to and detachable from the attachment portion, and the attachment portion is configured so that the toner container is to be attached to the attachment portion by being downwardly moved in a state that the cartridge is oriented in a positioning direction in which the attachment portion is positioned above the storage unit and that the cartridge is in contact with a horizontal plane, and a first contact portion, a second contact portion, and a third contact portion which are disposed on a bottom surface of the cartridge and configured to be brought into contact with the horizontal plane, wherein, when the cartridge oriented in the positioning direction is viewed in a gravity direction, at least a part of the attachment portion overlaps with a first region, where the first region is surrounded by a first virtual line connecting the first contact portion and the second contact portion, a second virtual line connecting the second contact portion and the third contact portion, a third virtual line connecting the third contact portion and the first contact portion, the first contact portion, the second contact portion, and the third contact portion.

Further features of the present disclosure will become apparent from the following description of exemplary embodiments with reference to the attached drawings.

### BRIEF DESCRIPTION OF THE DRAWINGS

FIG. 1 is a sectional view illustrating a process unit and a toner container according to a first exemplary embodiment.

FIGS. 2A and 2B are a main sectional view and a perspective view, respectively, illustrating an image forming apparatus according to the first exemplary embodiment.

FIGS. 3A and 3B are perspective views illustrating the process unit according to the first exemplary embodiment.

FIGS. 4A and 4B are a side view and a top view, respectively, illustrating the process unit according to the first exemplary embodiment.

FIG. 5 is a fragmentary perspective view illustrating an attachment portion according to the first exemplary embodiment.

FIGS. 6A and 6B are perspective views illustrating the attachment portion according to the first exemplary embodiment.

FIGS. 7A and 7B are fragmentary perspective views illustrating a toner pack according to the first exemplary embodiment.

FIGS. 8A and 8B are partial enlarged views illustrating the toner pack according to the first exemplary embodiment.

FIGS. 9A and 9B are perspective views illustrating the process unit with the toner pack attached thereto according to the first exemplary embodiment.

FIGS. 10A and 10B illustrate a relation between a region surrounded by straight lines connecting three different contact points on a contact plane and a position of the attachment portion according to the first exemplary embodiment.

FIGS. 11A and 11B illustrate a relation between a region surrounded by straight lines connecting three and four different contact points, respectively, on the contact plane and the position of the attachment portion according to the first exemplary embodiment.

### DESCRIPTION OF THE EMBODIMENTS

Exemplary embodiments for embodying the present disclosure will be described below with reference to the accompanying drawings.

A first exemplary embodiment of the present disclosure will be described in detail below with reference to the accompanying drawings.

### Image Forming Apparatus

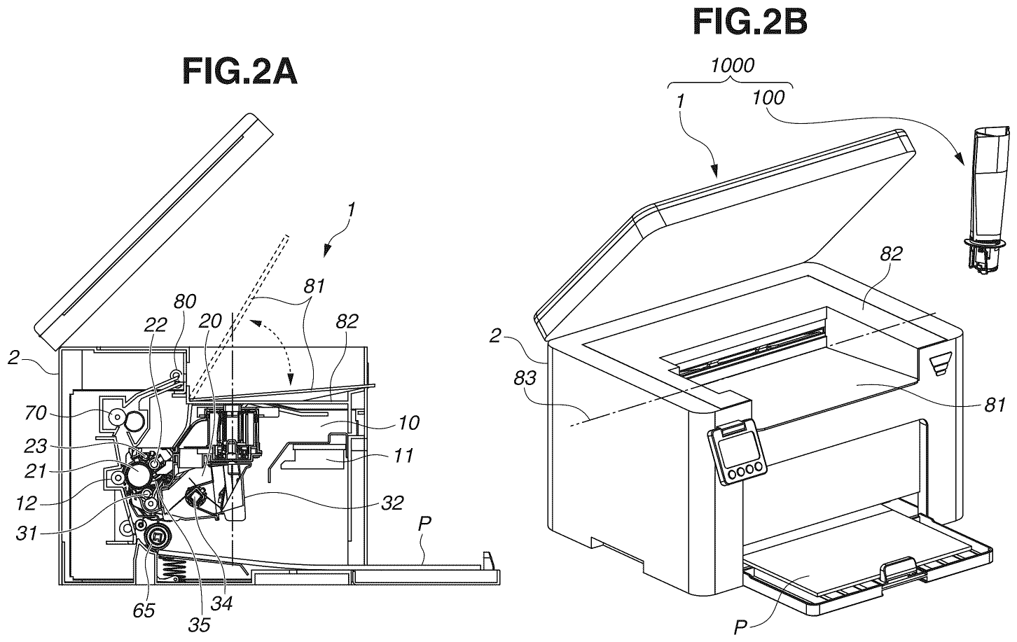

FIG. 2A is a main sectional view illustrating an overview of an image forming apparatus 1 according to the first exemplary embodiment. The image forming apparatus 1 is a monochrome printer for forming an image on a recording material P based on image information input from an external device. The recording material P includes various types of sheets made of different materials, such as paper (including plain paper and thick paper), plastic films (including overhead projector (OHP) sheets), special shape sheets (including envelopes and index paper), and cloths.

As illustrated in FIGS. 2A and 2B, a printer main body 2 as the apparatus body includes an image forming unit 10 for forming a toner image on the recording material P, a pickup roller 65 for feeding the recording material P to the image forming unit 10, a fixing unit 70 for fixing the toner image formed by the image forming unit 10 onto the recording material P, and a discharge roller pair 80.

The image forming unit 10 includes a scanner unit 11 (exposure unit), a process unit 20 (cartridge), and a transfer roller 12. The process unit 20 includes a drum unit 40 and a development unit 30. The drum unit 40 includes a photosensitive drum 21 (image carrier), a charge roller 22 (charging member), and a pre-exposure member 23. The development unit 30 includes a development roller 31 (toner carrier). The transfer roller 12 transfers a toner image formed on the photosensitive drum 21 to the recording material P.

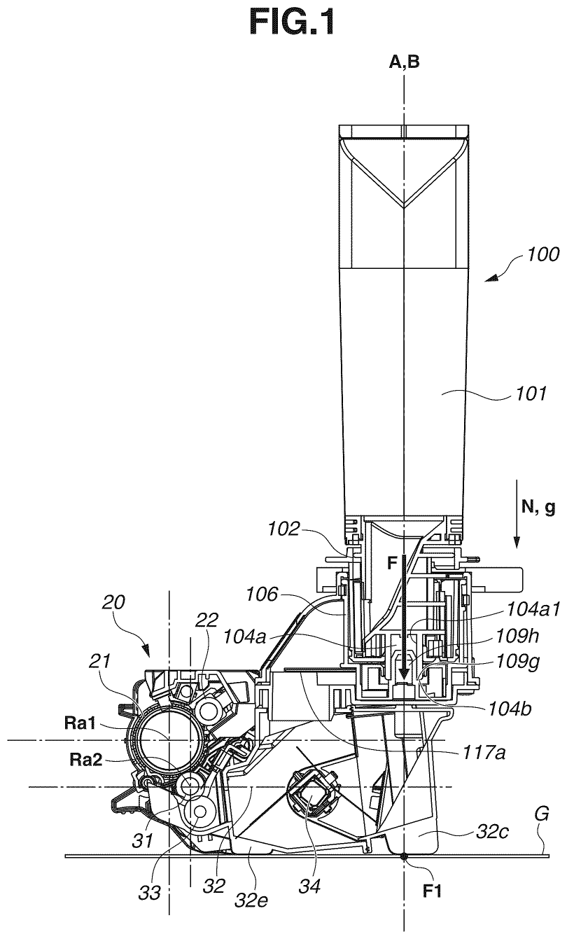

The photosensitive drum 21 is a photosensitive member having a cylindrical shape. The photosensitive drum 21 according to the present exemplary embodiment includes a drum-like substrate made of aluminum, and a photosensitive layer formed of a negatively charged organic photosensitive member on the substrate. The photosensitive drum 21 is rotatably driven at a predetermined process speed in a predetermined direction (clockwise direction in FIG. 1) around a rotational axis Ra1 (first rotational axis) by a motor (not illustrated).

The charge roller 22 comes into contact with the photosensitive drum 21 with a predetermined contact pressure to form a charging portion. The photosensitive drum 21 is applied with a desired charging voltage by a charging high-voltage power source so that the surface of the photosensitive drum 21 is uniformly charged to a predetermined potential. According to the present exemplary embodiment, the photosensitive drum 21 is negatively charged by the charge roller 22. The pre-exposure member 23 discharges the surface potential of the photosensitive drum 21 before entering the charging portion to generate a stable electric discharge at the charging portion.

The scanner unit 11 irradiates the photosensitive drum 21 with a laser beam corresponding to image information input from an external device by using a polygon mirror to perform scanning exposure on the surface of the photosensitive drum 21. This exposure process forms an electrostatic latent image corresponding to the image information on the surface of the photosensitive drum 21. The scanner unit 11 is not limited to a laser scanner apparatus. For example, a light emitting diode (LED) exposure unit having a LED array including a plurality of LEDs arranged along the longitudinal direction of the photosensitive drum 21 may be employed as the scanner unit 11.

The development unit 30 includes a development roller 31, a development container 32, and a feed roller 33 capable of supplying toner to the development roller 31. The development roller 31 and the feed roller 33 are rotatably supported by the development container 32. The development roller 31 rotates about a rotational axis Ra2 extending along the direction of the rotational axis Ra1, and is disposed at an opening of the development container 32 to face the photosensitive drum 21. The feed roller 33 is rotatably in contact with the development roller 31. The toner stored in the development container 32 is applied to the surface of the development roller 31 by the feed roller 33. The feed roller 33 is not necessarily used if a sufficient amount of toner can be supplied to the development roller 31.

The development unit 30 according to the present exemplary embodiment employs a contact development method. More specifically, a toner layer carried by the development roller 31 comes into contact with the photosensitive drum 21 at a development portion (development region) where the photosensitive drum 21 and the development roller 31 face each other. The development roller 31 is applied with a development voltage by a development high-voltage power source. When the toner carried by the development roller 31 is transferred from the development roller 31 to the surface of the photosensitive drum 21 in accordance with the potential distribution on the surface of the photosensitive drum 21 under the developing voltage, an electrostatic latent image is developed into a toner image. The present exemplary embodiment employs a reversal development method. More specifically, when the photosensitive drum 21 is charged in the charging process and then exposed in the exposure process, the surface region of the photosensitive drum 21 having an attenuated charge amount is applied with toner, and a toner image is formed.

In the present exemplary embodiment, a toner having a particle diameter of 6 μm and the negative normal charging polarity is used. In the present exemplary embodiment, a polymerised toner produced through a polymerization method is used. In the present exemplary embodiment, a toner containing no magnetic component, what is called a non-magnetic one-component toner, is used. This type of toner is carried by the development roller 31 mainly by the intermolecular force and electrostatic force (mirror image force). Alternatively, a one-component toner containing a magnetic component may be used. A one-component toner may contain an additive (e.g., wax or silica microparticles) for adjusting the flowability and charging performance of the toner in addition to toner particles. A two-component toner containing a non-magnetic toner and a magnetic carrier may be used. If a magnetic toner is used, for example, a cylindrical development sleeve having a magnet disposed inside is used as a toner carrier.

The development container 32 includes a toner storage chamber 36 (storage unit) and a stirring member 34 disposed inside the toner storage chamber 36. The stirring member 34 is driven by a motor (not illustrated) to rotate to stir the toner in the development container 32 and convey the toner toward the development roller 31 and the feed roller 33. The stirring member 34 also has a role of circulating the toner unused for the development and stripped off from the development roller 31 in the development container 32 to uniform the toner. The form of the stirring member 34 is not limited to the rotational form. For example, a stirring member configured to swing is also applicable.

The opening of the development container 32 where the development roller 31 is disposed is provided with a development blade 35 for regulating the amount of toner carried by the development roller 31. With the rotation of the development roller 31, the toner supplied on the surface of the development roller 31 passes through the portion facing the development blade 35. Thus, the toner is uniformly thinned and negatively charged through triboelectric charging.

The image forming operation of the image forming apparatus 1 will be described below. When an image forming instruction is input to the image forming apparatus 1, the image forming unit 10 starts the image forming process based on an image information input form an external computer connected to the image forming apparatus 1. The scanner unit 11 emits a laser beam to the photosensitive drum 21 based on the input image information. At this timing, the photosensitive drum 21 that has been pre-charged by the charge roller 22 is irradiated with a laser beam, and an electrostatic latent image is formed on the photosensitive drum 21. Subsequently, this electrostatic latent image is developed by the development roller 31, and a toner image is formed on the photosensitive drum 21.

In parallel with the above-described image forming process, the recording material P is sent out by the pickup roller 65 and then conveyed to a transfer nip formed by the transfer roller 12 and the photosensitive drum 21.

The transfer roller 12 is applied with a transfer voltage by a transfer high-voltage power source, and the toner image carried by the photosensitive drum 21 is transferred onto the recording material P. When the recording material P with the toner image transferred thereto is passing through the fixing unit 70, the toner image is heated and pressurized. Thus, toner particles are melted and then firmly fixed, and the toner image is fixed to the recording material P. After passing through the fixing unit 70, the recording material P is discharged out of the image forming apparatus 1 by the discharge roller pair 80 as a discharge member and then stacked on a discharge tray 81 as a stacking unit formed on the upper part of the printer main body 2.

A top cover 82 as a stacking tray is disposed at the upper part of the printer main body 2, and the discharge tray 81 as a stacking surface is formed on the top surface of the top cover 82. The top cover 82 is openably and closably supported by the printer main body 2 centering on a rotational axis 83. The top cover 82 is movable between an opening position at which the opening is open and a closing position at which the opening is closed. When the top cover 82 is set to the opening position, the process unit 20 passes through the opening while being attached to or detached from the printer main body 2. The exemplary embodiment employs a method in which the user detaches the process unit 20 from the image forming apparatus 1, attaches a toner pack 100 (toner container, see FIGS. 2A and 2B) to the process unit 20, and then supplies the toner from the toner pack 100 to the process unit 20 (hereinafter, this method is referred to as a direct supply method). After supplying the toner from the toner pack 100 to the process unit 20, the user detaches the toner pack 100 from the process unit 20 and then attaches the process unit 20 to the printer main body 2. Therefore, the image forming apparatus 1 with the direct supply method is easier to be downsized than image forming apparatuses in which the process unit 20 with the toner pack 100 attached is attached to the printer main body 2.

Further, in comparison with a configuration in which the process unit 20 is replaced, the above-described direct supply method eliminates the need of replacing the photosensitive drum 21 and the development roller 31 or reduces the replacement frequency, resulting in cost reduction. The image forming apparatus 1 and the toner pack 100 configure an imaging system 1000.

### Process Unit

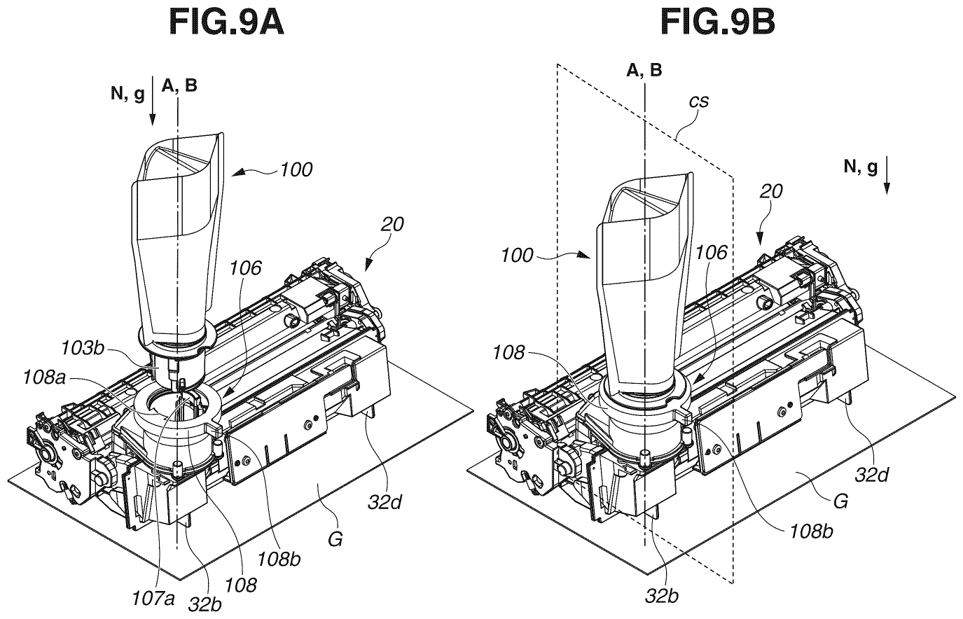

A configuration of the process unit 20 will be described below with reference to FIGS. 1, 6A, 6B, 9A, and 9B. FIG. 9A is a perspective view illustrating the process unit 20 and the toner pack 100 in a state where the toner pack 100 is being attached to an attachment portion 106 of the process unit 20. FIG. 9B is a perspective view illustrating the process unit 20 and the toner pack 100 in a state where the toner pack 100 has been attached to the attachment portion 106. FIG. 1 is a sectional view taken along the cross-section CS illustrated in FIG. 9B.

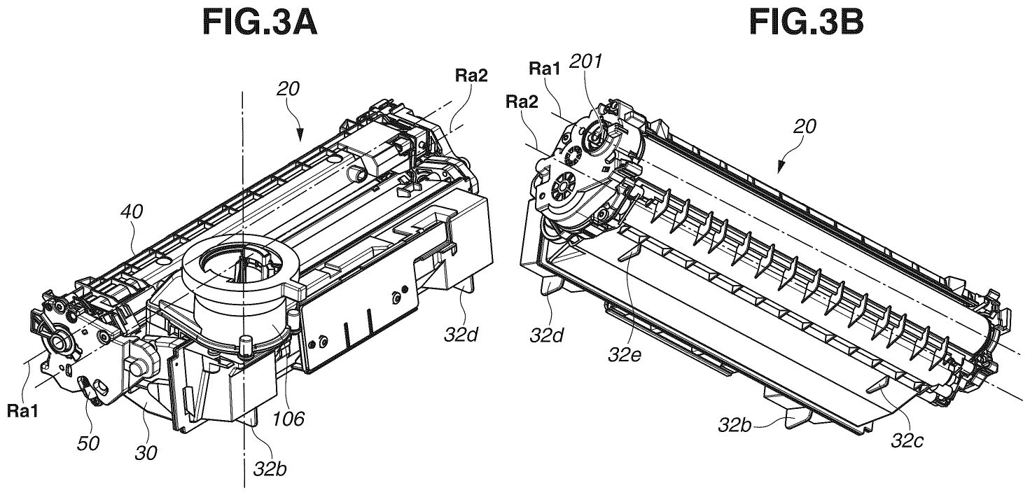

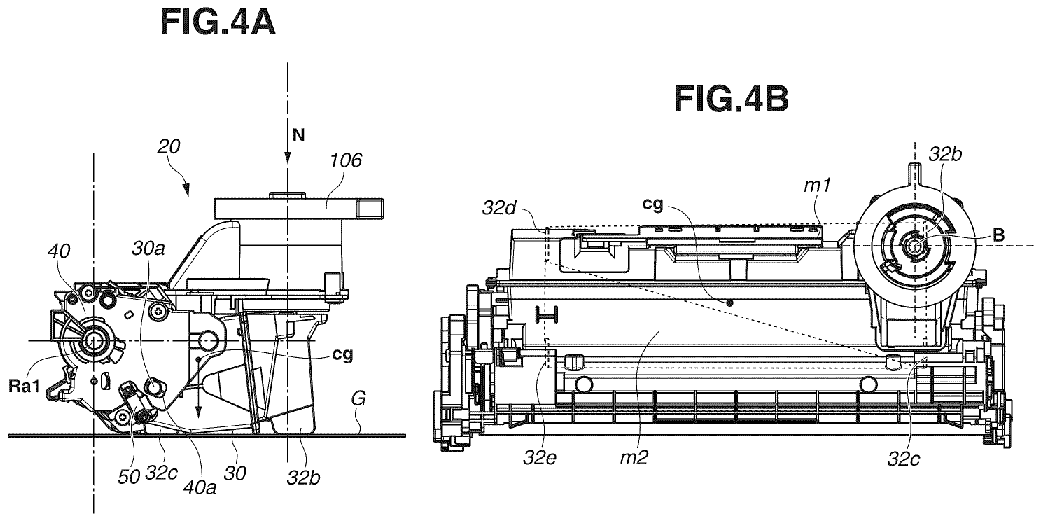

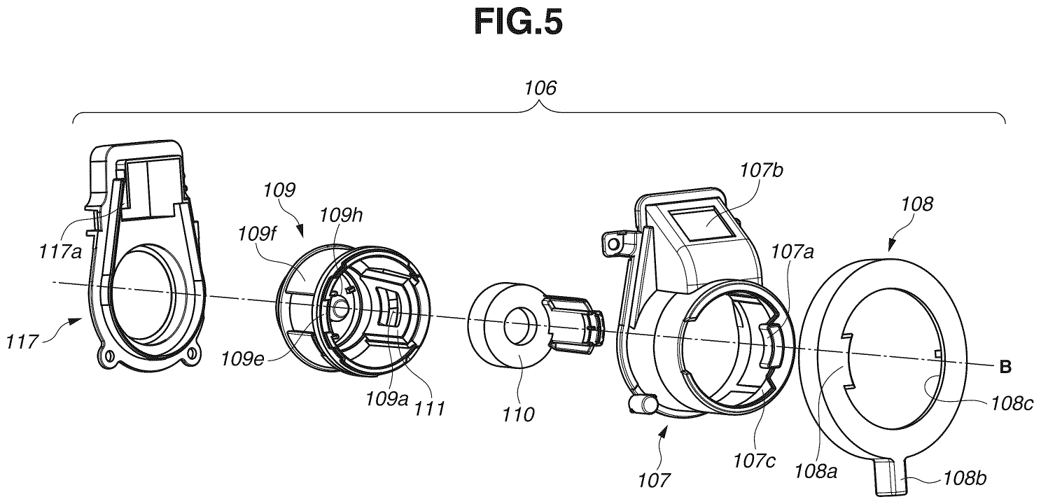

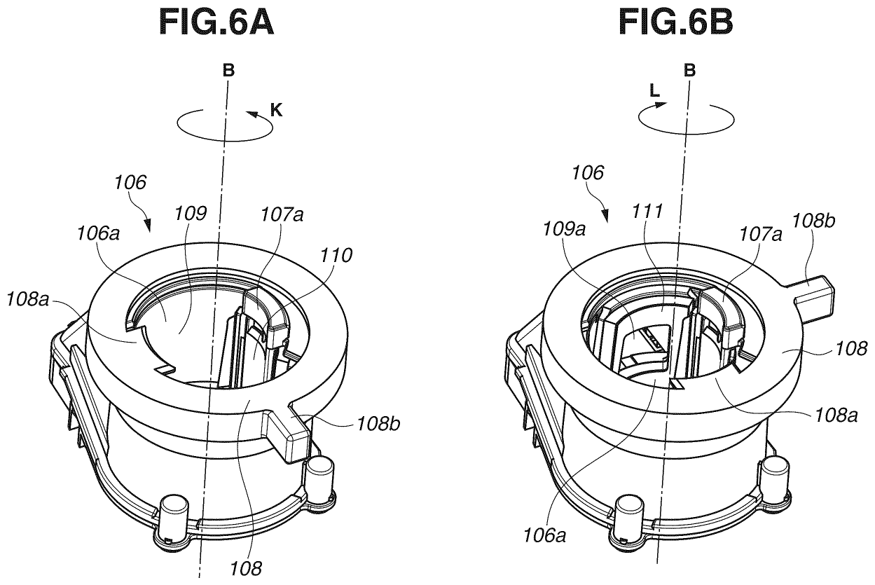

FIG. 3A is a perspective view illustrating the process unit 20. FIG. 3B is a perspective view illustrating the process unit 20 viewed from a viewpoint different from that in FIG. 3A. FIG. 4A is a side view illustrating the process unit 20. FIG. 4B is a top view illustrating the process unit 20. FIG. 5 is a fragmentary perspective view illustrating the attachment portion 106 of the process unit 20. FIG. 6A is a perspective view illustrating the attachment portion 106 in a state where an apparatus-side shutter 109 is closed. FIG. 6B is a perspective view illustrating the attachment portion 106 in a state where the apparatus-side shutter 109 is open.

As illustrated in FIGS. 1, 3A, 3B, and 4A, the process unit 20 includes the drum unit 40, the development unit 30, and a biasing member 50.

The drum unit 40 includes the photosensitive drum 21 rotatable about the rotational axis Ra1, the charge roller 22, and the pre-exposure member 23. The development unit 30 includes the development roller 31, the feed roller 33, the stirring member 34, the development container 32, and the attachment portion 106. As illustrated in FIG. 4A, a boss 30a fits into a hole 40a of the drum unit 40 so that the development unit 30 is rotatably supported by the drum unit 40. The boss 30a extends from an end in the direction of the rotational axis Ra1 of the development unit 30, along the direction of the rotational axis Ra1.

The biasing member 50 biases the development unit 30 to allow the development unit 30 to rotate relative to the drum unit 40 about the boss 30a so that the development roller 31 comes into contact with the photosensitive drum 21.

The attachment portion 106 is a portion where the toner pack 100 is attached. The attachment portion 106 is disposed on the development unit 30. As illustrated in FIGS. 6A and 6B, the attachment portion 106 has a hole 106a into which a tip end portion of the toner pack 100 is inserted. The attachment portion 106 is disposed at a position more apart from the center of the process unit 20 (development container 32) than the center of gravity cg along the direction of the rotational axis Ra2 of the development roller 31. The attachment portion 106 is disposed at an end of the process unit 20 (development container 32) in the direction of the rotational axis Ra2 of the development roller 31. When viewed along the direction of the rotational axis Ra1, the attachment portion 106 of the process unit 20 in contact with a contact plane G (horizontal plane) is positioned above the rotational axis Ra1 of the photosensitive drum 21.

As illustrated in FIG. 5, the attachment portion 106 includes a first frame 107, the apparatus-side shutter 109 (rotation member), an operation lever 108, a cover member 110, and a second frame 117.

The apparatus-side shutter 109 is a cylindrical member having an open upper part and is configured to rotate relative to the first frame 107 about the rotational axis B. The side surface of the apparatus-side shutter 109 extending along the rotational axis B is provided with an outer circumferential cylindrical surface 109f, a receiving inlet 109a penetrating the outer circumferential cylindrical surface 109f in the direction intersecting with the rotational axis B, and a driven transfer portion 109e concaved toward the rotational axis B relative to the outer circumferential cylindrical surface 109f.

The cover member 110 and the second frame 117 are fixed to the first frame 107. The first frame 107 is provided with a nozzle positioning member 107a projecting from an inner circumferential cylindrical surface 107c toward the rotational axis B.

The outer circumferential cylindrical surface 109f is rotatably supported by the inner circumferential cylindrical surface 107c of the first frame 107, so that the apparatus-side shutter 109 can rotate around the rotational axis B. The bottom surface of the apparatus-side shutter 109 is provided with an engagement shaft 109h that upwardly extends and is coaxially disposed with the rotational axis B. An upwardly oriented abutted surface 109g is disposed on the outer circumference of the engagement shaft 109h. An apparatus-side seal 111 is stuck around the receiving inlet 109a of the apparatus-side shutter 109.

The operation lever 108 includes an inner circumferential surface 108c forming the hole 106a, into which the tip end portion of the toner pack 100 is inserted, an operating portion 108b outwardly projecting in the direction orthogonal to the rotational axis B, and a shutter engagement portion 108a projecting from the inner circumferential surface 108c toward the rotational axis B.

The second frame 117 is provided with an apparatus-side opening 117a (supply inlet) and communicates with the toner storage chamber 36 in the development container 32.

The apparatus-side shutter 109 rotates about the rotational axis B to move between the first and the second positions. As illustrated in FIG. 6A, the first position is a non-communicating position at which the receiving inlet 109a and the apparatus-side opening 117a do not communicate with each other. As illustrated in FIG. 6B, the second position is a communicating position at which the receiving inlet 109a and the apparatus-side opening 117a communicate with each other.

The process unit 20 does not necessarily include the photosensitive drum 21. The development unit 30 including the attachment portion 106 may be configured to be attached to and detached from the printer main body 2. In this case, the drum unit 40 including the photosensitive drum 21 may be bound to the printer main body 2 or configured to be attachable to and detachable from the printer main body 2 independently of the development unit 30.

### Toner Pack

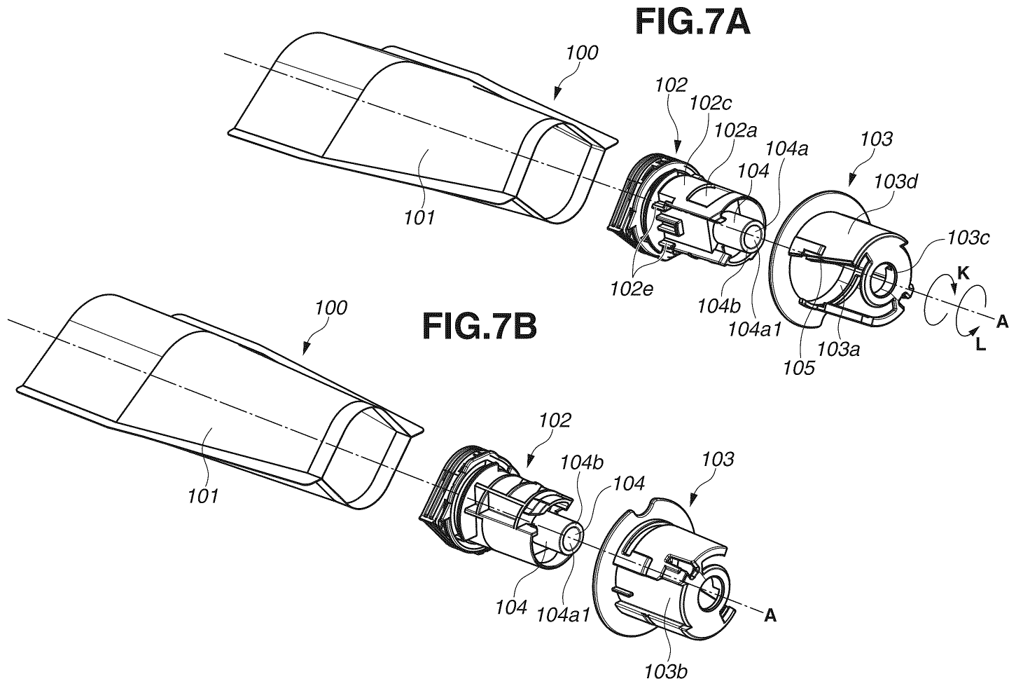

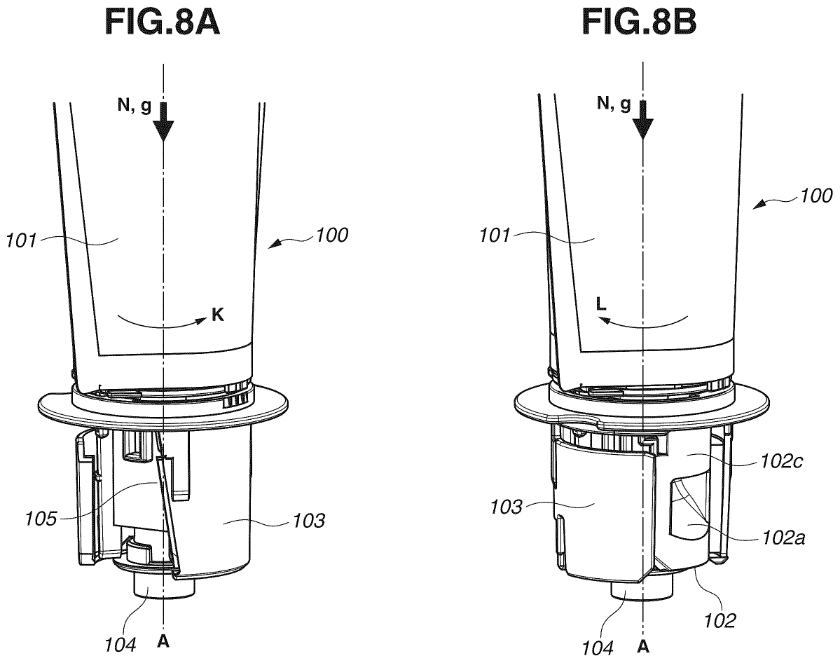

A configuration of the toner pack 100 will be described below with reference to FIGS. 7A, 7B, 8A, and 8B. FIG. 7A is a fragmentary perspective view illustrating the toner pack 100. FIG. 7B is a fragmentary perspective view illustrating the toner pack 100 viewed from a viewpoint different from that in FIG. 7A. FIG. 8A is a fragmentary perspective view illustrating the toner pack 100 when a pack-side shutter 103 is in the closing position. FIG. 8B is a fragmentary perspective view illustrating the toner pack 100 when the pack-side shutter 103 is in the opening position.

The toner pack 100 includes a storage unit 101, a nozzle 102, and the pack-side shutter 103. The storage unit 101 is disposed on one end side, and the nozzle 102 serving as the tip end portion of the toner pack 100 is disposed on the other end side along the direction of the rotational axis A of the pack-side shutter 103. More specifically, the storage unit 101 and the nozzle 102 are arranged in line along the direction of the rotational axis A.

According to the present exemplary embodiment, the storage unit 101 is formed like a bag with a flexible polypropylene sheet.

Although the storage unit 101 is formed like a bag through pouch processing, the present disclosure is not limited thereto.

The nozzle 102 has a side face 102c extending along the direction of the rotational axis A and having a discharge outlet 102a. The discharge outlet 102a is an opening that communicates with the inside of the storage unit 101. When the toner stored in the storage unit 101 is discharged out of the toner pack 100, the toner passes through this opening. The discharge outlet 102a opens in the direction intersecting with the rotational axis A.

The pack-side shutter 103 is disposed outside the nozzle 102 in the direction orthogonal to the rotational axis A of the nozzle 102. A pack-side seal 105 having an approximately rectangular shape is attached to the pack-side shutter 103. The pack-side shutter 103 is movable between a shielding position at which the pack-side seal 105 shields the discharge outlet 102a and an opening position at which the discharge outlet 102a is open. When the pack-side shutter 103 in the shielding position illustrated in FIG. 8A is rotated in the direction of the arrow K about the rotational axis A, the pack-side shutter 103 is set to the opening position illustrated in FIG. 8B. When the pack-side shutter 103 is rotated in the direction of the arrow L, the pack-side shutter 103 is set to the shielding position.

As illustrated in FIG. 7B, the nozzle 102 is provided with concave portions 102e (shutter engagement portions) concaved toward the rotational axis A relative to the side face 102c. The nozzle 102 has a projecting portion 104 downwardly projecting from the bottom surface of the nozzle 102 in a state where the rotational axis A is oriented in the gravity direction and the toner pack 100 is oriented in a predetermined direction in which the nozzle 102 is positioned below the storage unit 101. The projecting portion 104 has a hole 104a formed of an inner circumferential surface 104a1 with the rotational axis A as the center. The leading end of the projecting portion 104 has a downwardly oriented contact surface 104b (leading end surface).

A side face 103d of the pack-side shutter 103 has an opening 103a. The side face 103d is formed more outwardly than the side face 102c of the nozzle 102 when viewed along the direction of the rotational axis A. When the pack-side shutter 103 is at the closing position, the concave portions 102e of the nozzle 102 are exposed from the opening 103a. In this state, when the pack-side shutter 103 is rotated in the direction of the arrow K, the pack-side shutter 103 is set to the opening position, and the discharge outlet 102a of the nozzle 102 is exposed from the opening 103a. As illustrated in FIG. 7B, the pack-side shutter 103 is provided with a drive transfer portion 103b concaved toward the rotational axis A relative to the side face 103d.

### Contact Points of Process Unit

Before attachment of the toner pack 100 to the process unit 20, the process unit 20 is to be taken out from the printer main body 2 and then is to be brought into contact with the contact plane G. Grounding points on the process unit 20 will be described below with reference to FIGS. 4A and 4B.

As illustrated in FIG. 4B, the bottom surface of the process unit 20 includes four different contact points: a first contact point 32b (first contact portion), a second contact point 32c (second contact portion), a third contact point 32d (third contact portion), and a fourth contact point 32e (fourth contact portion) (hereinafter referred to as the first to fourth contact points).

The first to fourth contact points 32b, 32c, 32d, and 32e are disposed on the bottom surface of the process unit 20 when the process unit 20 is oriented in a (predetermined) direction where the attachment portion 106 is positioned above the development container 32. According to the exemplary embodiment, the bottom surface of the development container 32 includes the first to fourth contact points 32b, 32c, 32d, and 32e. According to the present exemplary embodiment, as illustrated in FIGS. 3B and 4A, the first to fourth contact points 32b, 32c, 32d, and 32e are projecting portions downwardly projecting from the bottom surface of the development container 32. The widths of the first to fourth contact points 32b, 32c, 32d, and 32e according to the present exemplary embodiment, the width in the direction orthogonal to both the direction of the rotational axis Ra2 of the development roller 31 and the gravity direction g is larger than the width in the direction of the rotational axis Ra2. The shapes of the first to fourth contact points 32b, 32c, 32d, and 32e are not limited to the shapes according to the present exemplary embodiment.

The first contact point 32b is disposed at a position closest to the attachment portion 106 among the first to fourth contact points when viewed in the gravity direction g. The second contact point 32c is disposed at an end on the side of the attachment portion 106 along the direction of the rotational axis Ra1. The second contact point 32c is located at a position closer to the photosensitive drum 21 (development roller 31) than the first contact point 32b along the direction orthogonal to the rotational axis Ra1. The third contact point 32d is disposed at an end on the side opposite to the side of the attachment portion 106 along the direction of the rotational axis Ra1. The third contact point 32d is disposed at the same position as the first contact point 32b along the direction orthogonal to the rotational axis Ra1. The fourth contact point 32e is disposed at an end on the side opposite to the side of the attachment portion 106 along the direction of the rotational axis Ra1. The second contact point 32c is located at a position closer to the photosensitive drum 21 (development roller 31) than the first contact point 32b along the direction orthogonal to the rotational axis Ra1.

According to the exemplary embodiment, with the process unit 20 in contact with the contact plane G in a predetermined orientation, three points including the first contact point 32b out of the first to fourth contact points 32b, 32c, 32d, and 32e come into contact with the contact plane G. If an unexpected external force is applied to the process unit 20 from above, all of the first to fourth contact points 32b, 32c, 32d, and 32e are configured to be brought into contact with the contact plane G.

Three contact points including the first contact point 32b may be configured to have larger projection height than that of the remaining one contact point that is to be brought into contact with the contact plane G if an unexpected external force is applied.

According to the present exemplary embodiment, the first to fourth contact points (32b, 32c, 32d, and 32e) are integrally formed with a resin frame forming the development container 32. However, at least one of the first to fourth contact points 32b, 32c, 32d, and 32e may be formed of an elastic member. In this case, all of the four contact points may be brought into contact with the contact plane G even under a normal condition where no unexpected external force is applied. A part of the first to fourth contact points (32b, 32c, 32d, and 32e) may be disposed on the bottom surface of the drum unit 40.

### Attaching Toner Pack to Attachment Portion

The attachment of the toner pack 100 to the attachment portion 106 will be described below with reference to FIGS. 1, 9A, and 9B.

FIG. 9A is a perspective view illustrating the process unit 20 and the toner pack 100 in a state where the toner pack 100 is being attached to the attachment portion 106 of the process unit 20. FIG. 9B is a perspective view illustrating the process unit 20 and the toner pack 100 in a state where the toner pack 100 has been attached to the attachment portion 106.

As illustrated in FIG. 9A, in a state where the rotational axis A is oriented in the gravity direction and the toner pack 100 is oriented so that the storage unit 101 is positioned above the nozzle 102, the toner pack 100 is downwardly moved and then attached to the attachment portion 106. According to the exemplary embodiment, the attachment direction of the toner pack 100 indicated by the direction of the arrow N coincides with the gravity direction. The toner pack 100 with the pack-side shutter 103 at the closing position is inserted into the attachment portion 106 with the apparatus-side shutter 109 at the non-communicating position, in the direction of the arrow N. In this process, the drive transfer portion 103b of the pack-side shutter 103 engages with the driven transfer portion 109e of the apparatus-side shutter 109 and the shutter engagement portion 108a of the operation lever 108.

Further, as illustrated in FIG. 1, when the toner pack 100 is attached to the attachment portion 106, the contact surface 104b of the projecting portion 104 comes into contact with the abutted surface 109g of the engagement shaft 109h of the attachment portion 106. This determines the position of the toner pack 100 relative to the attachment portion 106 (printer main body 2) in the direction of the arrow N (gravity direction). The engagement shaft 109h of the attachment portion 106 fits into the hole 104a of the projecting portion 104 of the toner pack 100 to determine the position of the toner pack 100 in the direction perpendicular to the attachment direction in which the toner pack 100 is attached to the attachment portion 106. Thus, the rotational axis A of the pack-side shutter 103 becomes approximately coaxial with the rotational axis B of the apparatus-side shutter 109.

As illustrated in FIGS. 6A and 6B, when the user holds the operating portion 108b of the operation lever 108 and rotates the operation lever 108 in the direction K, the shutter engagement portion 108a transmits the rotational driving force to the drive transfer portion 103b of the pack-side shutter 103 to rotate the pack-side shutter 103. With the rotation of the pack-side shutter 103, the drive transfer portion 103b transmits the rotational driving force to the driven transfer portion 109e of the apparatus-side shutter 109 to rotate the apparatus-side shutter 109. At this timing, the apparatus-side shutter 109 moves from the first position (non-communicating position) to the second position (communicating position), and the pack-side shutter 103 moves from the closing position to the opening position. With the above-described operation, the storage unit 101 of the toner pack 100 and the toner storage chamber 36 communicate with each other via the discharge outlet 102a, the receiving inlet 109a, and the apparatus-side opening 117a.

In this state, a force is applied to the storage unit 101 of the toner pack 100 from outside to deform the storage unit 101, so that the toner (not illustrated) in the storage unit 101 is supplied to the toner storage chamber 36 of the development container 32.

### Layout of Contact Points

When the toner pack 100 is attached to the attachment portion 106, the contact surface 104b of the projecting portion 104 of the toner pack 100 comes into contact with the abutted surface 109g of the engagement shaft 109h of the attachment portion 106.

Thus, the abutted surface 109g of the engagement shaft 109h receives an attachment force F from the toner pack 100. In other words, in a state where the process unit 20 is in contact with the contact plane G, the process unit 20 receives the attachment force F via the attachment portion 106. Therefore, it is desirable that the orientation of the process unit 20 is stable when the toner pack 100 is attached to the attachment portion 106. According to the present exemplary embodiment, the first to fourth contact points 32b, 32c, 32d, and 32e are disposed to stabilize the orientation of the process unit 20 when the toner pack 100 is attached to the attachment portion 106.

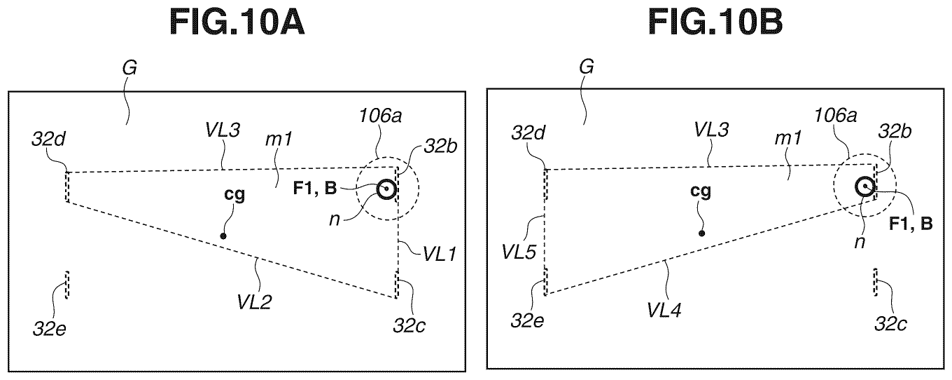

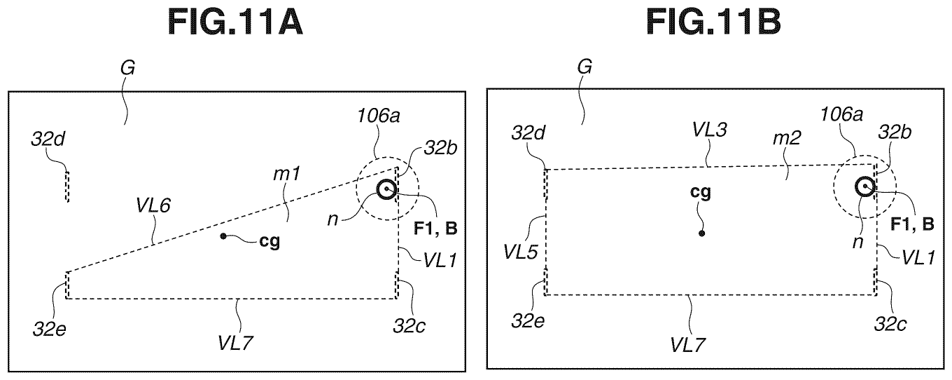

The layout of the first to fourth contact points 32b, 32c, 32d, and 32e according to the present exemplary embodiment will be described below with reference to FIGS. 4B, 10A, 10B, 11A, and 11B. FIGS. 10A, 10B, 11A, and 11B illustrate a state where the first to fourth contact points 32b, 32c, 32d, and 32e, the abutted surface 109g of the attachment portion 106, the center axis of the engagement shaft 109h (rotational axis B), and the center of gravity cg of the process unit 20 are projected on the contact plane G.

As illustrated in FIGS. 4B, 10A, 10B, 11A, and 11B, a region (first region) m1 is surrounded by any two of the second contact point 32c, the third contact point 32d, and the fourth contact point 32e, the first contact point 32b closest to the attachment portion 106 among the first to fourth contact points 32b, 32c, 32d, and 32e, and virtual lines connecting these points. A region (second region) m2 is surrounded by the first to fourth contact points 32b, 32c, 32d, and 32e and virtual lines connecting these points. Virtual lines are drawn so as to maximize the regions m1 and m2.

The region m1 in FIG. 10A is surrounded by a virtual line VL1 (first virtual line) connecting the first contact point 32b and the second contact point 32c, a virtual line VL2 (second virtual line) connecting the second contact point 32c and the third contact point 32d, and a virtual line VL3 (third virtual line) connecting the third contact point 32d and the first contact point 32b, and the first to third contact points. The region m1 in FIG. 10B is surrounded by a virtual line VL4 connecting the first contact point 32b and the fourth contact point 32e, a virtual line VL5 connecting the third contact point 32d and the fourth contact point 32e, a virtual line VL3 connecting the third contact point 32d and the first contact point 32b, the first contact point 32b, the third contact point 32d, and the fourth contact point 32e. The region m1 in FIG. 11A is surrounded by a virtual line VL1 connecting the first contact point 32b and the second contact point 32c, a virtual line VL7 connecting the second contact point 32c and the fourth contact point 32e, a virtual line VL6 connecting the fourth contact point 32e and the first contact point 32b, the first contact point 32b, the second contact point 32c, and the fourth contact point 32e.

The region m2 in FIG. 11B is surrounded by a virtual line VL1 connecting the first contact point 32b and the second contact point 32c, a virtual line VL7 connecting the second contact point 32c and the fourth contact point 32e, a virtual line VL5 connecting the fourth contact point 32e and the third contact point 32d, a virtual line VL3 connecting the first contact point 32b and the third contact point 32d, and the first to fourth contact points.

As illustrated in FIGS. 10A, 10B, 11A, and 11B, a region n is pressed when the abutted surface 109g of the attachment portion 106 comes into contact with the contact surface 104b of the projecting portion 104 of the toner pack 100. Further, in the region n, the abutted surface 109g (attachment portion) receives an attachment force F that acts at a point of action F1 (center of the region n). According to the exemplary embodiment, the point of action F1 is the center axis of the engagement shaft 109h, the rotational axis B of the apparatus-side shutter 109, and the center of the hole 106a of the attachment portion 106 into which the nozzle 102 of the toner pack 100 is inserted.

According to the present exemplary embodiment, as illustrated in FIGS. 10A, 10B, and 11A, three contact points to be brought into contact with the contact plane G are disposed so that at least a part of the hole 106a of the attachment portion 106 overlaps with the region m1 (including the virtual lines forming the region m1). This prevents an unstable orientation of the process unit 20 when the toner pack 100 is attached to the attachment portion 106 and the process unit 20 is applied with the attachment force F. To achieve a stable orientation of the process unit 20, it is desirable that three contact points to be brought into contact with the contact plane G are disposed so that the region n or the point of action F1 overlaps with the region m1 (including the virtual lines forming the region m1). Further, to achieve a stable orientation of the process unit 20, it is desirable that three contact points to be brought into contact with the contact plane G are disposed so that the center of gravity cg of the process unit 20 overlaps with the region m1, as illustrated in FIGS. 10A, 10B, and 11A. When viewed in the gravity direction, the first contact point 32b overlaps with the hole 106a of the attachment portion 106. Therefore, even with the large attachment force F of the toner pack 100, the process unit 20 can be supported by the first contact point 32b close to the point of action F1.

Referring to FIGS. 10A, 10B, and 11A, the fourth contact point 32e, the second contact point 32c, and the third contact point 32d are disposed, respectively, to be brought into contact with the contact plane G only if an unexpected external force is applied. To achieve a stable orientation of the process unit 20, it is desirable that at least a part of the hole 106a of the attachment portion 106 overlaps with the region m2 (including the virtual lines forming the region m2), as illustrated in FIG. 11B, if an unexpected external force is applied to the process unit 20 and these contact points are in contact with the contact plane G. To achieve a stable orientation of the process unit 20, it is desirable that the region n or the point of action F1 overlaps with the region m2. Referring to FIGS. 10A, 10B, and 11A, the fourth contact point 32e, the second contact point 32c, and the third contact point 32d may be omitted, respectively.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-084304, filed May 23, 2023, which is hereby incorporated by reference herein in its entirety.

What is claimed is:

1. A cartridge which a toner container is attachable to and detachable from, the cartridge including a development roller and a storage unit for storing toner to be carried by the development roller, the cartridge comprising:
an attachment portion having a supply inlet through which toner is supplied to the storage unit from outside of the cartridge, wherein the toner container is attachable to and detachable from the attachment portion, and the attachment portion is configured so that the toner container is to be attached to the attachment portion by being downwardly moved in a state that the cartridge is oriented in a positioning direction in which the attachment portion is positioned above the storage unit and that the cartridge is in contact with a horizontal plane; and
a first contact portion, a second contact portion, and a third contact portion which are disposed on a bottom surface of the cartridge and configured to be brought into contact with the horizontal plane,
wherein, when the cartridge oriented in the positioning direction is viewed in a gravity direction, at least a part of the attachment portion overlaps with a first region, where the first region is surrounded by a first virtual line connecting the first contact portion and the second contact portion, a second virtual line connecting the second contact portion and the third contact portion, a third virtual line connecting the third contact portion and the first contact portion, the first contact portion, the second contact portion, and the third contact portion.

2. The cartridge according to claim 1, wherein, when the cartridge oriented in the positioning direction is viewed in the gravity direction, a center of the attachment portion overlaps with the first region.

3. The cartridge according to claim 2,
wherein the attachment portion has a hole into which a tip end portion of the toner container is inserted, and the hole has a cylindrical inner circumferential surface, and
wherein the center of the attachment portion coincides with a center of the hole.

4. The cartridge according to claim 2,
wherein, in the state that the cartridge is oriented in the positioning direction and is in contact with the horizontal plane, the attachment portion includes an upwardly projecting engagement shaft for engaging with the toner container to determine a position of the toner container in a direction orthogonal to an attachment direction in which the toner container is attached to the attachment portion, and
wherein the center of the attachment portion coincides with a center axis of the upwardly projecting engagement shaft.

5. The cartridge according to claim 2,
wherein, in the state that the cartridge is oriented in the positioning direction and is in contact with the horizontal plane, the attachment portion includes a rotation member configured to rotate about a rotational axis extending in the gravity direction, and
wherein the center of the attachment portion coincides with the rotational axis.

6. The cartridge according to claim 1, wherein, when the cartridge oriented in the positioning direction and in contact with the horizontal plane is viewed in the gravity direction, the first contact portion overlaps with the at least a part of the attachment portion.

7. The cartridge according to claim 1, wherein, when the cartridge oriented in the positioning direction and in contact with the horizontal plane is viewed in the gravity direction, a center of gravity of the cartridge overlaps with the first region.

8. The cartridge according to claim 7, wherein the attachment portion is located at a position farther from a center of the cartridge than the center of gravity along a direction of a rotational axis of the development roller.

9. The cartridge according to claim 1, wherein the attachment portion is disposed at an end portion of the cartridge in a direction of a rotational axis of the development roller.

10. The cartridge according to claim 1, wherein, when the cartridge oriented in the positioning direction and in contact with the horizontal plane is viewed in the gravity direction, a width of the first contact portion in a direction orthogonal to both a direction of a rotational axis of the development roller and the gravity direction is larger than a width of the first contact portion in the positioning direction of the rotational axis.

11. The cartridge according to claim 10, wherein, when the cartridge oriented in the positioning direction and in contact with the horizontal plane is viewed in the gravity direction, a width of the second contact portion in the positioning direction orthogonal to both the positioning direction of the rotational axis and the gravity direction is larger than the width of the second contact portion in the positioning direction of the rotational axis.

12. The cartridge according to claim 1, further comprising a photosensitive drum configured to be supplied with toner from the development roller.

13. The cartridge according to claim 12, wherein, in the cartridge oriented in the positioning direction and in contact with the horizontal plane, the attachment portion is positioned above the photosensitive drum.

14. The cartridge according to claim 1, wherein, in the cartridge oriented in the positioning direction and in contact with the horizontal plane, the first contact portion, the second contact portion, and the third contact portion downwardly project.

15. The cartridge according to claim 14, further comprising a fourth contact portion configured to be brought into contact with the horizontal plane, at a position different from the first contact portion, the second contact portion, and the third contact portion,
wherein, in the cartridge oriented in the positioning direction and in contact with the horizontal plane, the fourth contact portion projects downwardly.
